(19) United States
(12) Patent Application Publication
(10) Pub. No.: US 2009/0102347 A1
(43) Pub. Date: Apr. 23, 2009

(54) Lamp With A Holdings Element

(76) Inventors: Thomas Helmstreit, Eichstatt (DE); Andreas Nittke, Pietenfeld (DE); Ingo Zenth, Oberschleissheim (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/225,034

(22) PCT Filed: Mar. 13, 2007
(86) PCT No.: PCT/EP2007/052347

§ 371 Date: Sep. 12, 2008

(30) Foreign Application Priority Data
Mar. 29, 2006 (DE) 10 2006 014 643.3

(51) Int. Cl. H01K 1/18

(52) U.S. Cl. 313/290

(57) ABSTRACT

A lamp is disclosed, in particular a halogen incandescent lamp which is intended for the medium-voltage or high-voltage range, having a lamp vessel which is pinched at one end and in whose interior at least one luminous element with at least two luminous element limbs is accommodated, and which is closed by means of a pump rod tip, with the luminous element being fixed in position in the lamp vessel by means of a holding element arranged in the pump rod tip. According to the invention, the holding element is held by means of a centre part in a holding section of the pump rod tip, with free end sections of the holding element being provided for holding the luminous element.

### TECHNICAL FIELD

The invention relates to a lamp, in particular a halogen incandescent lamp intended for the medium-voltage or high-voltage range, with a lamp vessel which has a pinch seal at one end and in whose interior at least one luminous element with at least two luminous element limbs is accommodated, and which is closed by means of an exhaust tube tip, the luminous element being fixed in position in the lamp vessel via a holding element arranged in the exhaust tube tip.

### PRIOR ART

DE 296 20 098 U1 has disclosed a halogen incandescent lamp in which a luminous element in the form of an incandescent filament is accommodated in a lamp vessel. The lamp vessel is sealed off at one end by a pinch seal, through which a power supply system for the incandescent filament is passed. Since such lamps are operated in the medium-voltage and high-voltage range, they have a relatively long, not intrinsically stable incandescent filament, which is tentered in the interior of the lamp vessel via a bar-type frame embedded in the pinch seal or by means of pinch-sealing knobs introduced into the lamp vessel in such a way that the filament segments are spaced apart from one another, for example are arranged in the form of a U or V. One disadvantage with such lamps is the fact that, as a result of the bar-type frame, shadows and disruptive structures in the illumination of the room may arise or, as a result of the pinch-sealing knobs, the lamp vessel geometry may be impaired and this would result in impaired optical properties of the lamp.

In order to improve the optical properties of the lamp, it is known, for example, from GB 1 178 062 B1 to fix the incandescent filament in the lamp vessel via a holding element arranged in the exhaust tube tip, with the result that the incandescent filament limbs are tentered approximately in the form of a V in the interior of the lamp vessel. With this solution, one end of a holding wire, for example by means of a helical extension, is inserted into the exhaust tube from the outside and fixed in the exhaust tube tip. The free end of the holding wire is shaped to form a hook-shaped holder, in which the connecting region of the incandescent filament limbs is held. One disadvantage with such lamps is the fact that, owing to the incandescent filament limbs which are tentered in the form of a V and the high operating voltage, there may result an arc discharge between the incandescent filament sections arranged adjacent to one another. This arc results from a short circuit between filament parts which can be brought about, for example, by two filament limbs coming into contact with one another. Owing to the short-circuit current, such high temperatures may occur in the pinch seal that the lamp may explode. In order to prevent such thermal overloading of the pinch seal, DE 296 20 098 U1 has proposed that at least a subregion of an inner power supply line is designed to have a comparatively small cross section and is embedded in the pinch seal. In the event of the occurrence of a short-circuit current, some of the wire material within the pinch seal vaporizes and this results in a free capillary, along which the discharge initially continues to burn. Above an effective length of the free capillary, the discharge arc comes to be extinguished automatically very quickly. Such a form of protection is also referred to as intrinsic protection. It has been shown that it is not possible in some application cases to select the diameter of the power supply line to be so small that it meets the requirements of DE 296 20 098 U1, with the result that further safety precautions are required.

Furthermore, it is known, for example, from U.S. Pat. No. 5,270,609 B1 to provide the incandescent filament with an arcuate central part and to clamp it into an accommodating area of the exhaust tube tip via said central part. Disadvantages with this solution are the fact that the relatively sensitive incandescent filament needs to be handled when bending the central part and the production of the filament is complex in terms of manufacturing technology and difficult to automate owing to the bent central part. It has furthermore been shown that the spring force of the incandescent filament is insufficient for a secure hold in the exhaust tube tip.

### DESCRIPTION OF THE INVENTION

The invention is based on the object of providing a lamp in which the production of an arc given improved positioning of the filament in the lamp vessel in comparison with conventional solutions is avoided.

This object is achieved according to the invention by a lamp, in particular a halogen incandescent lamp intended for the medium-voltage or high-voltage range, with a lamp vessel which has a pinch seal at one end and in whose interior at least one luminous element with at least two luminous element limbs is accommodated, and which is closed by means of an exhaust tube tip, the luminous element being fixed in position in the lamp vessel via a holding element arranged in the exhaust tube tip. According to the invention, the holding element is held via a central part in an accommodating section of the exhaust tube tip, with free end sections of the holding element being provided for holding the luminous element. Particularly advantageous embodiments of the invention are described in the dependent claims.

Owing to the holding element which is held in the accommodating section of the exhaust tube tip via the central part, the two free ends can be used for holding the luminous element, with the result that the luminous element limbs are tentered in the lamp vessel in such a way that they are physically spaced apart from one another, and electrical flashovers between the luminous element limbs are effectively prevented. As a result, the power supply lines can be designed to have an optimum cross section for the lamp life in contrast with the prior art in accordance with DE 296 20 098 U1. The holding element takes on the function of mechanically fixing the luminous element, with the result that a separate bar-type frame or pinch-sealing knobs, as are required in the solution disclosed in DE 296 20 098 U1, can be dispensed with and the complexity in terms of apparatus is substantially reduced in comparison therewith. The positioning of the luminous element with respect to the lamp vessel wall can be set in a defined manner in the case of the lamp according to the invention owing to the incandescent filament which is in each case held by an end section of the holding element, with the result that the efficiency of a coating, for example a reflective coating which reflects radiation in the infrared wavelength region (IR region) or visible wavelength region (VIS region), is substantially improved.

In accordance with a particularly preferred exemplary embodiment of the invention, the holding element is in the form of a wire clip, which is inserted in a sprung manner from the interior of the lamp vessel, via the elastically flexible central part, into the accommodating section of the exhaust tube tip and is held therein in a force-fitting and/or form-fitting manner. The wire clip is preferably formed from tungsten wire.

In order to accommodate and hold the holding element in the accommodating section, at least sections of the central part are preferably matched to the inner contour of the accommodating section. In an exemplary embodiment according to the invention, at least sections of the central part are arcuate, preferably being in the form of a single or multiple helix.

In an embodiment of the lamp according to the invention, the accommodating section of the exhaust tube tip has a constriction, with the result that the holding element is held via the central part in a form-fitting and force-fitting manner in the accommodating section. As a result, the hold of the holding element in the accommodating region of the exhaust tube tip is further improved.

Preferably, the holding element has at least two spring limbs for holding the luminous element in the lamp vessel. These spring limbs are preferably bent away from one another towards the outside, with the result that the longitudinal axes of the luminous element limbs are arranged substantially parallel with respect to one another. It has proven to be particularly advantageous if the spring limbs run towards the luminous element approximately in the form of a V. This makes it possible for the incandescent filament limbs to be tentered broadly with the result that the risk of contact between the luminous element limbs is further minimized.

In order to make it possible to thread the luminous element easily into the holding element and then to prevent the luminous element from sliding out, in an exemplary embodiment according to the invention at least sections of the free end sections of the spring limbs are bent outwards and are approximately helical.

In accordance with a preferred exemplary embodiment of the lamp according to the invention, the luminous element is in the form of an incandescent filament which is bent approximately in the form of a U and on whose luminous element limbs in each case at least one filament section is formed. Preferably, the incandescent filament is held via the connecting region between the filament sections in the holding regions of the holding element.

In addition to the clamping hold, the central part of the holding element can be at least partially fused into the accommodating section of the exhaust tube tip when the exhaust tube is fused shut.

In a preferred embodiment of the lamp, the power supply sections of the luminous element are connected to molybdenum foils, which are arranged in a pinch seal and on which in turn in each case one outer power supply line, in particular a contact pin, is fastened, which contact pin protrudes out of the pinch seal.

### BRIEF DESCRIPTION OF THE DRAWINGS

The invention will be explained in more detail below with reference to preferred exemplary embodiments. In the drawings:

FIG. 1 shows a front view of a first exemplary embodiment of a lamp according to the invention with an axial reflector, and

FIG. 2 shows a detail view of a second exemplary embodiment of a lamp according to the invention with a cylindrical lamp vessel.

### PREFERRED EMBODIMENT OF THE INVENTION

The invention will be explained below with reference to a halogen reflector lamp with a base at one end using high-voltage technology, as is used in large quantities, for example in general lighting.

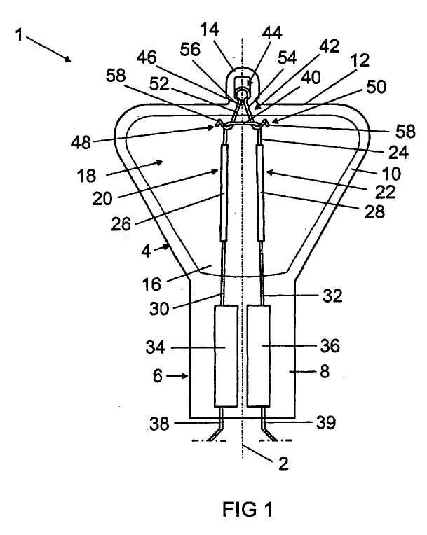

First, a first exemplary embodiment of a lamp according to the invention with an axial reflector is explained with reference to FIG. 1.

FIG. 1 shows a lamp in the form of an HV halogen reflector lamp 1 with a lamp vessel 4, which consists of quartz glass and is rotationally symmetrical about a lamp longitudinal axis 2 and on whose lower (in FIG. 1) end section a base 8 is formed by means of a pinch seal 6, via which base 8 the halogen reflector lamp 1 can be inserted into a lampholder (not illustrated). The pinch seal 6 becomes a vessel section 10 of the lamp vessel 4, which vessel section 10 extends in the form of a funnel and is in the form of a conical axial reflector. That end section of the lamp vessel 4 which is remote from the base 8 is formed by a dome 12, which has an exhaust tube tip 14 which is arranged diametrically with respect to the pinch seal 6 and onto which an exhaust tube was placed during manufacture of the lamp 1 in order to evacuate the interior of the lamp vessel 4 and to fill it with a filling gas containing halogens. After the filling process, the exhaust tube was removed and the exhaust tube attachment fused shut to form the exhaust tube tip 14. The quartz glass of the lamp vessel 4 is provided with dopants absorbing ultraviolet radiation. A luminous element 18 with two luminous element limbs 20, 22 is arranged in the interior 16 of the lamp vessel 4, and this luminous element 18, in the exemplary embodiment illustrated, is in the form of an incandescent filament 24, which is bent approximately in the form of a U and on whose luminous element limbs 20, 22 in each case one filament section 26, 28 is arranged. The luminous element limbs 20, 22 are connected via power supply sections 30, 32 to molybdenum foils 34, 36, which are embedded in the pinch seal 6 and on which in turn in each case one outer power supply line is fastened, which power supply line is in the form of a contact pin 38, 39 and protrudes out of the pinch seal 6. The incandescent filament 24 is tentered on a connecting region 40 between the filament sections 26, 28 via a holding element 42, which has been inserted into the exhaust tube tip 14, in the interior 16 of the lamp vessel 4 in such a way that the filament sections 26, 28 are spaced apart from one another substantially in the form of a U. According to the invention, the holding element 42 is held via a central part 44 in an accommodating section 46 of the exhaust tube tip 14, with free end sections 48, 50 of the holding element 42 being provided for holding the incandescent filament 24, with the result that the luminous element limbs 20, 22 are tentered in the lamp vessel 4 in such a way that they are physically spaced apart from one another and electrical flashovers between the luminous element limbs 20, 22, which result in an arc discharge, are effectively prevented. The holding element 42 takes on the function of mechanically fixing the incandescent filament 24 in the lamp vessel 4, with the result that a special bar-type frame or pinch-sealing knobs in the lamp vessel 4 can be dispensed with. As a result, the complexity in terms of apparatus for the manufacture of the lamp 1 according to the invention is substantially reduced.

In the exemplary embodiment illustrated, the holding element 42 is in the form of a wire clip made from tungsten, which is inserted in a sprung manner from the interior 16 of the lamp vessel 4 via the elastically flexible central part 44 into the accommodating section of the exhaust tube tip 14. For this purpose, sections of the central part 44 are designed to be arcuate, and the central part 44 becomes two spring limbs 52, 54 for holding the incandescent filament 24 in the lamp vessel 4. The substantially cylindrical accommodating section 46 of the exhaust tube tip 14 is provided with a constriction 56, which surrounds sections of the arcuate central part 44, with the result that the wire clip 42 is held in the accommodating section 46 in a form-fitting and force-fitting manner. In addition to the clamping hold, the central part 44 can be at least partially fused into the accommodating section 46 of the exhaust tube tip 14 when the exhaust tube tip 14 is fused. The spring limbs 52, 54 are bent away from one another towards the outside approximately in the form of a V, with the result that the longitudinal axes of the luminous element limbs 20, 22 are tentered in the lamp vessel 4 in such a way that they are spaced apart substantially parallel with respect to one another. This makes it possible for the luminous element limbs 20, 22 to be tentered broadly, with the result that the risk of contact is further minimized. The free end sections 48, 50 of the spring limbs 52, 54 are bent outwards and sections of them are approximately helical in order to make it easier to thread the incandescent filament 24 into the wire clip 42 and then to prevent it from sliding out therefrom.

In an exemplary embodiment which has not been illustrated, the central part 44 of the wire clip 42 is in the form of a single or multiple helix and is held thereby in the accommodating section 46 of the exhaust tube tip 14.

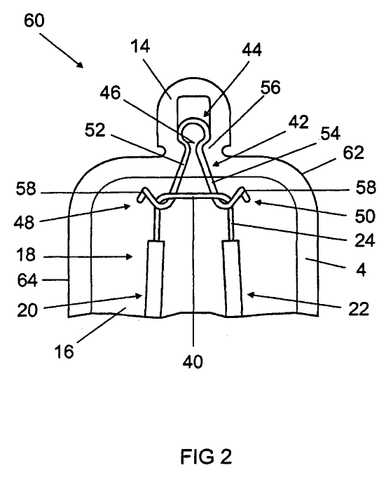

FIG. 2 shows a detail view of a halogen lamp 60 in the region of the wire clip 42 in accordance with a second exemplary embodiment according to the invention. This exemplary embodiment differs from the above-described exemplary embodiment substantially by virtue of the fact that the lamp vessel 4 is approximately cylindrical. That end section of the lamp vessel 4 which is remote from the base (not illustrated) is in this exemplary embodiment formed by a spherical dome 62, on which the exhaust tube tip 14 is formed. The outer circumferential area 64 of the lamp vessel 4 is provided with a coating reflecting radiation in the infrared wavelength region. Owing to the incandescent filament 24 which is held in each case by the end sections 48, 50 of the wire clip 42, the positioning of the incandescent filament 24 with respect to the lamp vessel wall can be set in a defined manner, with the result that the efficiency of the coating is substantially improved in comparison with lamp vessels with pinch-sealing knobs.

The invention is not restricted to the exemplary embodiments explained in more detail above; in particular the invention can be used with incandescent lamps 1, 60 with any desired lamp vessel geometry and with different coatings. Furthermore, it is also possible for the wire clip 42 to be held in the exhaust tube tip 14 without the mentioned constriction 56 of the accommodating section 46 merely by means of the clamping effect of the central part 44.

The invention discloses a lamp 1, 60, in particular a halogen incandescent lamp intended for the medium-voltage or high-voltage range, with a lamp vessel 4, which has a pinch seal at one end and in whose interior 16 at least one luminous element 18 with at least two luminous element limbs 20, 22 is accommodated and which is closed by means of an exhaust tube tip 14, the luminous element 18 being fixed in position in the lamp vessel 4 via a holding element 42 arranged in the exhaust tube tip 14. According to the invention, the holding element 42 is held via a central part 44 in an accommodating section 46 of the exhaust tube tip 14, with free end sections 48, 50 of the holding element 42 being provided for holding the luminous element 18.

1. A lamp with a lamp vessel (4) which has a pinch seal at one end and in whose interior (16) at least one luminous element (18) with at least two luminous element limbs (20, 22) is accommodated, and which is closed by means of an exhaust tube tip (14), the luminous element (18) being fixed in position in the lamp vessel (4) via a holding element (42) arranged in the exhaust tube tip (14), characterized in that the holding element (42) is held via a central part (44) in an accommodating section (46) of the exhaust tube tip (14), with free end sections (48, 50) of the holding element (42) being provided for holding the luminous element (18).

2. The lamp as claimed in claim 1, the holding element (42) being a wire clip, which is inserted in a sprung manner from the interior (16) of the lamp vessel (4), via the elastically flexible central part (44), into the accommodating section (46) of the exhaust tube tip (14) and is held therein in a force-fitting and/or form-fitting manner.

3. The lamp as claimed in claim 1 or 2, at least sections of the central part (44) being matched to the inner contour of the accommodating section (46).

4. The lamp as claimed in claim 1, at least sections of the central part (44) being arcuate, preferably being in the form of a single or multiple helix.

5. The lamp as claimed in either of claims 2 and 4, the accommodating section (46) of the exhaust tube tip (14) having a constriction (56), with the result that the holding element (42) is held via the central part (44) in a form-fitting and force-fitting manner in the accommodating section (46).

6. The lamp as claimed in claim 1, the holding element (42) having at least two spring limbs (52, 54) for holding the luminous element (18) in the lamp vessel (4).

7. The lamp as claimed in claim 6, the spring limbs (52, 54) being bent away from one another towards the outside approximately in the form of a V.

8. The lamp as claimed, in claim 6 or 7, at least sections of the free end sections (48, 50) of the spring limbs (52, 54) being bent outwards and being approximately helical.

9. The lamp as claimed in claim 1, the luminous element (18) being an incandescent filament (24), which is bent approximately in the form of a U and on whose luminous element limbs (20, 22) in each case at least one filament section (26, 28) is formed.

10. The lamp as claimed in claim 9, the connecting region (40) between the filament sections (26, 28) being held in the end sections (48, 50) of the holding element (42).

11. The lamp as claimed in claim 1, the holding element (42) being formed from tungsten wire.

12. The lamp as claimed in claim 1, at least part of the central part (44) being fused into the accommodating section (46) of the exhaust tube tip (14).

13. The lamp as claimed in claim 1, power supply sections (30, 32) of the luminous element (18) being connected to molybdenum foils (34, 36), which are arranged in a pinch seal (6) and on which in turn in each case one outer power supply line (38), in particular a contact pin, is fastened, which contact pin protrudes out of the pinch seal (6).

14. The lamp as claimed in claim 1, at least sections of the lamp vessel (4) being provided with a coating which is reflective in the VIS and/or IR region.

15. The lamp as claimed in claim 1 which is a halogen incandescent lamp for use in the medium-voltage or high-voltage range.
